(19) United States
(12) Patent Application Publication
(10) Pub. No.: US 2003/0222859 A1
(43) Pub. Date: Dec. 4, 2003

(54) Method of producing an internal structure of a PDA pen tube

(76) Inventors: Chao-Chi Huang, Taipei (TW); Ming-Chung Chiu, Keelung (TW)

Correspondence Address: Raymond Sun, 12420 Woodhall Way, Tustin, CA, 92782, US

(21) Appl. No.: 10/159,407

(22) Filed: May 30, 2002

(51) Int. Cl. G09G 5/00

(52) U.S. Cl. 345/179

(57) ABSTRACT

A method of making a tube for a PDA pen includes the steps of providing a tube having a hollow interior, coating a metal layer on the internal surface of the hollow interior, covering a portion of the metal layer on the internal surface, and producing an oxide layer on the uncovered portions of the metal layer so that the uncovered portions of the metal layer are electrically non-conductive and the covered portion of the metal layer remains electrically conductive.

### BACKGROUND OF THE INVENTION

1. Field of the Invention

The present invention relates to a method for making the tube of a PDA pen.

2. Description of the Prior Art

PDAs (personal digital assistant) have become increasingly popular in recent years. Its popularity can be attributed to a number of factors, including: (1) the fact that it can often function like a personal computer (PC), (2) the fact that it can be conveniently operated by using a touch control pen to touch and choose items on its screen, and (3) the fact that its small size is convenient for carrying about in a pocket, handbag, briefcase or other small carrying bag.

An important component of every PDA system is the PDA pen. In general, the upper surface of the PDA has a touch control screen and a push key zone. A groove is cut from an upper side edge of the PDA. The PDA pen may be stored in the internal space of the groove. During usage, the stylus of the PDA pen is used to touch the touch control screen of the PDA to cause the PDA to execute the programs or instructions selected by the user.

In co-pending application Ser. No. 10/039,696, filed Jan. 4, 2002, entitled “Touch Control Pen for PDA”, the present applicant discloses a PDA pen that incorporates a light source retained in the pen holder for generating light that can be used to illuminate the touch control screen in use, so that the PDA can be used even in dark environments. An LED structure provides the illumination and is powered by a battery.

However, PDA pens must be provided in a small size since the size of conventional PDAs are necessarily quite small. To meet these size requirements, a special lithium battery (e.g., model of BR435 having 3V) has been provided. This lithium battery uses a front portion thereof as a negative pole and a rear portion is used as a positive pole. As a result, the printed circuit board (PCB) for the PDA pen must be installed in the front portion of the tube or housing of the PDA pen for conductive purposes. This means that the rear portion of the tube must be isolated to avoid electrical shorts. To isolate the rear portion of the tube, it is possible to place a metal layer inside the tube, and then use a plastic tubular member as an isolative structure inside the tube of the PDA pen. Unfortunately, this approach will enlarge the inside diameter of the tube, which is undesirable because this may cause the outer diameter of the tube to be so large that the PDA pen may not fit inside the groove of the PDA housing.

Thus, there remains a need for a PDA pen that addresses the problems described above.

### SUMMARY OF THE DISCLOSURE

It is an object of the present invention to provide a PDA pen that has a tube where a portion of the tube is isolated to avoid electrical shorts.

It is another object of the present invention to provide a PDA pen that has a tube which has a diameter that is small enough to allow the PDA pen to fit inside the groove of a conventional PDA.

It is yet another object of the present invention to provide a PDA which can provide illumination of the screen in dark environments.

To achieve the above objectives, the present invention provides a method of making a tube for a PDA pen where the following steps are accomplished:

providing a tube having a hollow interior that has an internal surface;

coating a metal layer on the internal surface;

covering a portion of the metal layer on the internal surface; and

producing an oxide layer on the uncovered portions of the metal layer so that the uncovered portions of the metal layer are electrically non-conductive and the covered portion of the metal layer remains electrically conductive.

The above-described method can be used to produce a PDA pen that has a tube, an illuminating element provided at the forward end of the tube, a control circuit retained inside the hollow interior of the tube, a metal layer provided on the internal surface of the tube at one portion of the tube, and an isolative layer provided on the internal surface of the tube at another portion of the tube, with the metal layer electrically connecting the control circuit to the illuminating element.

### BRIEF DESCRIPTION OF THE DRAWINGS

FIG. 1 illustrates an apparatus that provides an anodized treatment for a PDA pen tube according to one embodiment of the present invention.

FIG. 2 illustrates another step in the anodized treatment of FIG. 1.

FIG. 3 illustrates a PDA pen tube after it has received the anodized treatment illustrated in FIGS. 1 and 2.

FIG. 4 is a sectional side view of a PDA pen that includes the PDA pen tube of FIG. 3, after the PDA pen has been assembled for use.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

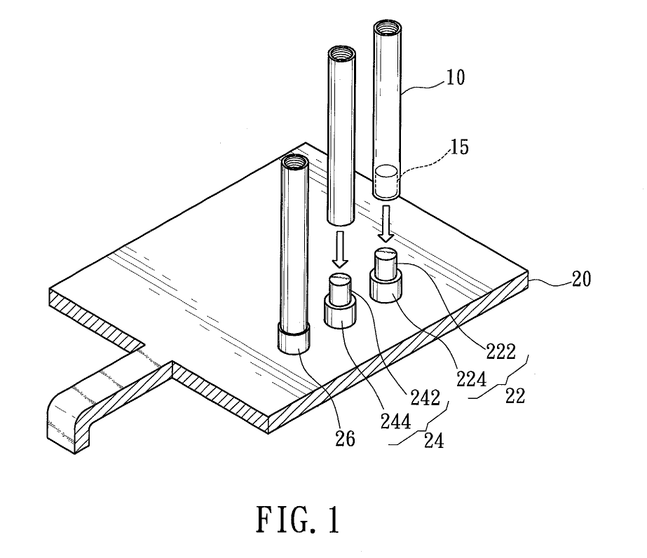

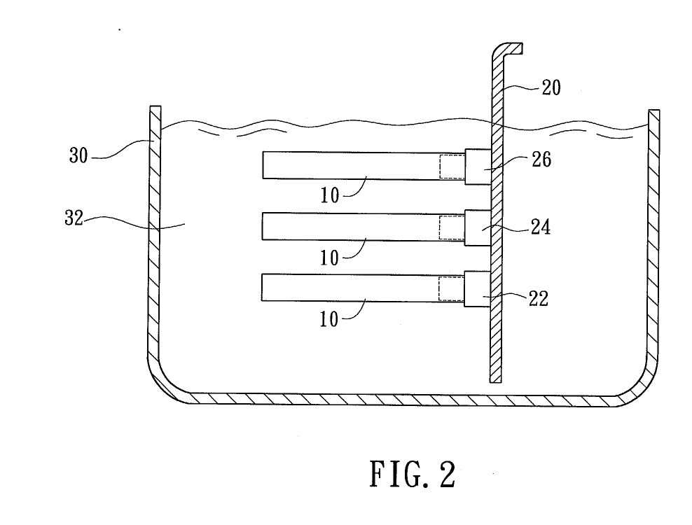

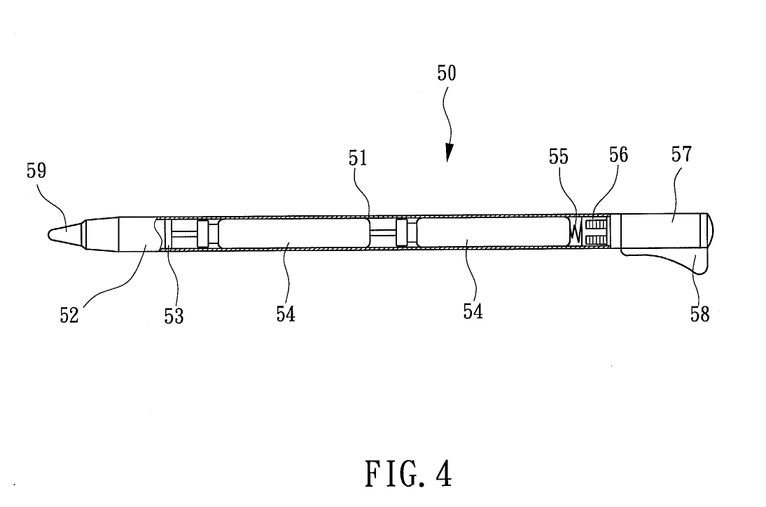

Referring first to FIG. 4, FIG. 4 illustrates a PDA pen 50 that includes a pen tube processed according to the method illustrated in FIGS. 1 and 2 hereinbelow. The PDA pen 50 has a pen tube 51, a cap 57 and an LED stylus 59. The LED stylus 59 can produce light to illuminate the touch control screen of a PDA. The interior wall of the front end of the pen tube 51 has a metal layer 52 that electrically connects a PCB 53 (acting as a control circuit) to control the illumination of the LED 59. At least one battery 54 (FIG. 4 shows two batteries 54) is retained inside the tube 51, with the batteries 54 having a front end that is electrically coupled to the PCB 53. The rear end of pen tube 51 retains a spring 55 and a conductive block 56 that are positioned between the batteries 54 and the cap 57. The cap 57 is fitted at the rear end of the pen tube 51. The bias of the spring 55 against the block 56 and the batteries 54 function to retain the batteries 54 firmly in place inside the pen tube 51 to maintain the necessary electrical connection. The cap 57 also has an external protruding gripping block 58 which can be used by a user to push the PDA pen 50 out of the groove of a PDA. Although FIG. 4 provides a very simple and general description of an illuminating PDA pen 50, the PDA pen 50 can have a structure and operation that is very similar to the PDA pens shown and described in co-pending application Ser. No. 10/039,696, filed Jan. 4, 2002, entitled “Touch Control Pen for PDA”, whose disclosure is incorporated by this reference as though set forth fully herein.

FIGS. 1 and 2 illustrate a method of producing a pen tube 10 (which is the same as pen tube 51 described above) according to the present invention in which the rear portion of the tube 10 is isolated to avoid electrical shorts, yet which has a sufficiently small diameter so that the tube 10 can be fitted inside the groove of any conventional PDA. The method illustrated in FIGS. 1 and 2 involves anodizing a portion of the tube 10. First, a base plate 20 is provided for processing pen tubes 10. Each base plate 20 has a plurality of identical plugs 22, 24, 26. Each plug (e.g., 22) itself defines a lower primary plug 224 and an upper secondary plug 222, with the secondary plug 222 having a smaller diameter than the primary plug 224. The plug 24 also has a primary plug 244 and a smaller-diameter secondary plug 242.

Next, each tube 10 is fitted on to a separate plug 22, 24, 26 by placing one open end of the tube 10 over the secondary plug 222 and 242 of a corresponding plug 22, 24 or 26. A metal layer (e.g., aluminum) is then coated on to the internal surface of the tube 10. The area of the internal surface of each tube 10 that is occupied by a corresponding secondary plug 222, 242 defines an occupied area 15 on the internal surface at one end of the tube 10. Thus, the size of the occupied area 15 is determined by the size and shape of the secondary plug 222 or 242.

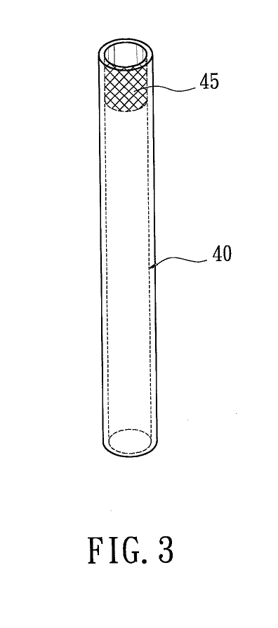

Next, as shown in FIG. 2, the base plate 20 and the tubes 10 that have been fitted over the plugs 22, 24, 26 are turned sideways (e.g., by tilting or turning the base plate 20 by ninety degrees) and placed into an electrolyte solution 32 of an electrobath 30 for anodized treatment. Since each occupied area 15 is being blocked by a corresponding secondary plug 222, 242, the occupied areas 15 are not exposed to electrolyte 32, so that an oxide (e.g., aluminum oxide) is not formed on these occupied areas 15, thereby still leaving a conductive metal layer at the occupied areas 15. The metal on the other portions of the internal surface that are not occupied or blocked by the secondary plugs 222, 242 will react with the electrolyte 32 to produce an oxide (e.g., aluminum oxide) that functions as an isolative layer. As a non-limiting example, aluminum oxide is a ceramic material having features of isolation and hardness. In other words, the metal layer not occupied by a secondary plug 222, 242 in tube 10 is transformed into an oxide layer 40 (see FIG. 3) for isolative function, while the portion of the metal layer occupied by a secondary plug 222, 242 remains a conductor 45. FIG. 3 illustrates the pen tube 10 after being processed in the manner described and illustrated in connection with FIGS. 1 and 2.

Referring back to FIG. 4, the conductive portion 45 of the tube 10 is the location where the PCB 53 is positioned. Thus, the conductive portion 53 can electrically connect the PCB 53 with the LED stylus 59, while having the rest of the tube 10 be electrically isolated to avoid electrical shorts.

Thus, by utilizing the original metal layer on the internal surface of a tube 10 and isolating a selected portion of this metal layer prior to an oxidation treatment, the present invention can accomplish the objective of isolating a portion of the tube 10 to avoid electrical shorts, yet still providing the tube 10 with a diameter that is small enough to allow the tube 10 to be fitted inside the groove of any conventional PDA.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A method for producing a tube for a PDA pen, comprising:
providing a tube having a hollow interior that has an internal surface;
coating a metal layer on the internal surface;
covering a portion of the metal layer on the internal surface; and
producing an oxide layer on the uncovered portions of the metal layer so that the uncovered portions of the metal layer are electrically non-conductive and the covered portion of the metal layer remains electrically conductive.

2. The method of claim 1, wherein the step of producing an oxide layer on the uncovered portions of the metal layer includes the step of exposing the uncovered portions to an electrolyte solution.

3. The method of claim 2, wherein the step of exposing the uncovered portions to an electrolyte solution includes dipping the tube into an electrobath.

4. The method of claim 1, wherein the step of covering a portion of the metal layer on the internal surface includes the step of inserting a plug into one end of the tube so that the plug covers the covered portion.

5. The method of claim 1, wherein the metal layer is aluminum.

6. The method of claim 1, wherein the oxide layer is aluminum oxide.

7. The method of claim 1, wherein the step of coating a metal layer on the internal surface includes coating the metal layer on the entire internal surface.

8. A PDA pen, comprising:
a tube having a forward end and a rear end, and having a hollow interior that has an internal surface;
an illuminating element provided at the forward end;
a control circuit retained inside the hollow interior of the tube;
a metal layer provided on the internal surface at a first portion of the tube;
an isolative layer provided on the internal surface at a second portion of the tube; and
wherein the metal layer electrically connects the control circuit to the illuminating element.

9. The pen of claim 8, further including a power source retained inside the hollow interior of the tube and coupled to the control circuit.

10. The pen of claim 8, wherein the first portion is the forward end of the pen, and the second portion is the rear end of the pen.

11. A method for producing a tube for a PDA pen, comprising:
providing a base plate having at least one plug provided thereon;
providing a tube having a hollow interior that has an internal surface;
coating a metal layer on the entire internal surface;
inserting one of the plugs into one end of the tube so that the plug covers a portion of the metal layer on the internal surface; and
producing an oxide layer on the uncovered portions of the metal layer so that the uncovered portions of the metal layer are electrically non-conductive and the covered portion of the metal layer remains electrically conductive.

12. The method of claim 11, when the step of exposing the uncovered portions to an electrolyte solution includes dipping the tube and a portion of the base plate into an electrobath.
